(19) United States
(12) Patent Application Publication
(10) Pub. No.: US 2010/0185608 A1
(43) Pub. Date: Jul. 22, 2010

(54) INFORMATION RETRIEVAL DEVICE, INFORMATION RETRIEVAL SYSTEM, INFORMATION RETRIEVAL PROGRAM AND INFORMATION RETRIEVAL METHOD

(75) Inventors: Yukie Hagiwara, Matsumoto (JP); Chie Kawashima, Azumino (JP); Yosuke Nakano, Higashi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/685,121

(22) Filed: Jan. 11, 2010

(30) Foreign Application Priority Data
Jan. 21, 2009 (JP) 2009-010642

(51) Int. Cl. G06F 17/30

(52) U.S. Cl. 707/723; 707/769; 707/E17.109

(57) ABSTRACT

Provided is an information retrieval device connected to a content server which stores contents to be retrieved through a network, the information retrieval device including: a content storing unit storing contents including some of the contents stored in the content server; a retrieval request reception unit receiving contents retrieval request for the content server and the content storing unit; a first retrieval unit acquiring a first retrieval result of the contents stored in the content storing unit based on the retrieval request received by the retrieval request reception unit; a second retrieval unit acquiring a second retrieval result of the contents stored in the content server based on the retrieval request received by the retrieval request reception unit; and an integrated retrieval result display unit displaying an integrated retrieval result obtained by integrating the first retrieval result and the second retrieval result.

### BACKGROUND

1. Technical Field

The present invention relates to an information retrieval device using a network, an information retrieval system, an information retrieval program and an information retrieval method.

2. Related Art

In the past, if a seller or a manufacturer of a Personal Computer (PC) provides technical and troubleshooting information (hereinafter referred to as “support information”) to a user (PC purchaser), for example, a method of accumulating the support information on the use of the PC in a server connected to a network and enabling the user to access the server through the network from a terminal device such as a PC so as to retrieve the support information accumulated in the server has been used.

In addition, a method of storing in advance support information in a PC to be sold and retrieving the support information stored in the PC if a user needs to refer to the support information has been used.

As described above, with respect to the provision of the support information, since there are a provision method using a network and a provision method of storing the support information in a purchased PC, in the past, a user individually retrieves the support information in the server or the purchased PC.

As the technology of integrating the retrieval of the support information in each of the server and the purchased PC, the technology described in JP-A-2005-216302 is known.

In the technology described in JP-A-2005-216302, heterogeneous resources, which should be retrieved due to having the highest relevance, are determined and a local retrieval (PC retrieval) result and a Web retrieval (server retrieval) result are displayed as a list for each of the retrieved resources (information sources).

However, in the technology described JP-A-2005-216302, since the local retrieval result and the Web retrieval result are displayed as the list for each of the retrieved resources (information sources), the user needs to individually check the retrieval results so as to find the necessary information.

That is, in the known technology, it is difficult to efficiently retrieve the information stored in the terminal device such as the PC and information accumulated on the network so as to display the retrieval results in a form for easily facilitating the checking of the results.

### SUMMARY

An advantage of some aspects of the invention is that information stored in a terminal device and information accumulated on a network are efficiently retrieved so as to display the retrieval results in a form for easily facilitating the checking of the results.

In order to solve the above-described problems, according to an aspect of the invention, there is provided an information retrieval device connected to a content server which stores contents to be retrieved through a network, the information retrieval device including: a content storing unit which store contents including some of the contents stored in the content server; a retrieval request reception unit which receives contents retrieval requests for the content server and the content storing unit; a first retrieval unit which acquires a first retrieval result of the contents stored in the content storing unit based on the retrieval request received by the retrieval request reception unit; a second retrieval unit which acquires a second retrieval result of the contents stored in the content server based on the retrieval request received by the retrieval request reception unit; and an integrated retrieval result display unit which displays an integrated retrieval result obtained by integrating the first retrieval result and the second retrieval result.

By this configuration, it is possible to acquire the results of performing the retrieval of the contents stored in the content storing unit and the content server according to the retrieval request received by the retrieval request reception unit and to integrate the display of the results.

Accordingly, it is possible to efficiently retrieve information stored in a terminal device and information accumulated on the network and to provide the retrieval result in a form for easily facilitating the checking of the results.

According to another aspect of the invention, the information retrieval device may further include an identification information storing unit which stores an identification information specifying the configuration of the information retrieval device, and the second retrieval unit may acquire the second retrieval result of the contents stored in the content server based on the retrieval request received by the retrieval request reception unit and the identification information stored in the identification information storing unit.

By this configuration, it is possible to narrow the contents retrieved in the content server so there is a search for more appropriate contents.

According to another aspect of the invention, the integrated retrieval result display unit may display the integrated retrieval result in order of the score of the contents of the retrieval request, and display contents included in the first retrieval result at the top when the contents included in the first retrieval result and the contents included in the second retrieval result have the same score.

By this configuration, it is possible to preferentially display the contents of the information retrieval device which have higher relevance with the information retrieval device, out of the contents stored in the content server and the contents stored in the information retrieval device, and to display the retrieval results in an appropriate order.

According to another aspect of the invention, the contents to be retrieved may be support information used for supporting the use of the information retrieval device, and the content storing unit may store contents used for troubleshooting connection problems of the network.

By this configuration, even in a state in which the content server cannot be accessed, it is possible to easily resolve trouble in accessing the content server by using the contents stored in the information retrieval device and to include the contents stored in the content server as an object which can be retrieved with more certainty.

According to another aspect of the invention, there is provided an information retrieval system in which a content server, which stores contents to be retrieved, and an information retrieval device, which performs a retrieval request of the contents to be retrieved, are connected through a network, wherein the content server includes a content database storing contents to be retrieved, and a content retrieval unit performing retrieval of the contents stored in the content database according to the retrieval request of the information retrieval device, and the information retrieval device includes a content storing unit storing contents including some of the contents stored in the content server, a retrieval request reception unit receiving contents retrieval requests for the content server and the content storing unit, a first retrieval unit acquiring a first retrieval result of the contents stored in the content storing unit based on the retrieval request received by the retrieval request reception unit, a second retrieval unit acquiring a second retrieval result of the contents stored in the content server based on the retrieval request received by the retrieval request reception unit, and an integrated retrieval result display unit displaying an integrated retrieval result obtained by integrating the first retrieval result and the second retrieval result.

By this configuration, it is possible to acquire the results of performing the retrieval of the contents stored in the content storing unit and the content server according to the retrieval request received by the retrieval request reception unit and to display the integrated result.

Accordingly, it is possible to efficiently retrieve information stored in a terminal device and information accumulated on the network and to provide the retrieval results in a form for easily facilitating the checking of the results.

According to another aspect of the invention, there is provided an information retrieval program for controlling an information retrieval device which is connected to a content server storing contents to be stored and has a content storing unit storing contents including some of the contents stored in the content server, which executes, on a computer, the information retrieval program including a retrieval request reception function of receiving contents retrieval requests for the content server and the content storing unit; a first retrieval function of acquiring a first retrieval result of the contents stored in the content storing unit based on the retrieval request received by the retrieval request reception function; a second retrieval function of acquiring a second retrieval result of the contents stored in the content server based on the retrieval request received by the retrieval request reception function; and an integrated retrieval result display function of displaying an integrated retrieval result obtained by integrating the first retrieval result and the second retrieval result.

By this configuration, it is possible to acquire the results of performing the retrieval of the contents stored in the content storing unit of the information retrieval device and the content server according to the retrieval request received by the retrieval request reception function and to display the integrated result.

Accordingly, it is possible to efficiently retrieve information stored in a terminal device and information accumulated on the network and to provide the retrieval results in a form for easily facilitating the checking of the results.

According to another aspect of the invention, there is provided an information retrieval method of an information retrieval system in which a content server which stores contents to be retrieved and an information retrieval device, which has a content storing unit storing contents including some of the contents stored in the content server and performs a retrieval request of the contents to be retrieved, are connected through a network, the information retrieval method including: a first step of receiving a retrieval request of the contents stored in the content server and the content storing unit, in the information retrieval device; a second step of performing retrieval of the contents stored in a content database according to the retrieval request of the information retrieval device, in the content server having the content database storing contents to be retrieved; a third step of acquiring a first retrieval result of the contents stored in the content storing unit based on the retrieval request received in the first step, in the information retrieval device; a fourth step of acquiring a second retrieval result of the contents stored in the content server based on the retrieval request received in the first step, in the information retrieval device; and a fifth step of displaying an integrated retrieval result obtained by integrating the first retrieval result and the second retrieval result, in the information retrieval device.

By this configuration, it is possible to acquire the results of performing the retrieval of the contents stored in the content storing unit of the information retrieval device and the content server according to the retrieval request received in the first step and to display the integrated result.

Accordingly, it is possible to efficiently retrieve information stored in a terminal device and information accumulated on the network and to provide the retrieval results in a form for easily facilitating the checking of the results.

### BRIEF DESCRIPTION OF THE DRAWINGS

The invention will be described with reference to the accompanying drawings, wherein like numbers reference like elements.

FIG. 1 is a diagram showing a network configuration of an information retrieval system.

FIG. 2 is a block diagram showing the functional configurations of a content server.

FIG. 3 is a diagram showing the contents of a support information database.

FIG. 4 is a block diagram showing the functional configurations of a PC.

FIG. 5 is a flowchart showing an integrated retrieval process executed by a CPU of the PC.

FIG. 6 is a flowchart showing a network trouble resolving process executed by the CPU.

FIG. 7 is a flowchart showing a content retrieval process executed by a CPU of the content server.

FIG. 8 is a flowchart showing an integrated retrieval process according to Application 1.

### DESCRIPTION OF EXEMPLARY EMBODIMENTS

Hereinafter, an information retrieval system, an information retrieval device, an information retrieval program and an information retrieval method according to the embodiments of the invention will be described with reference to the accompanying drawings.

### First Embodiment

### Configuration

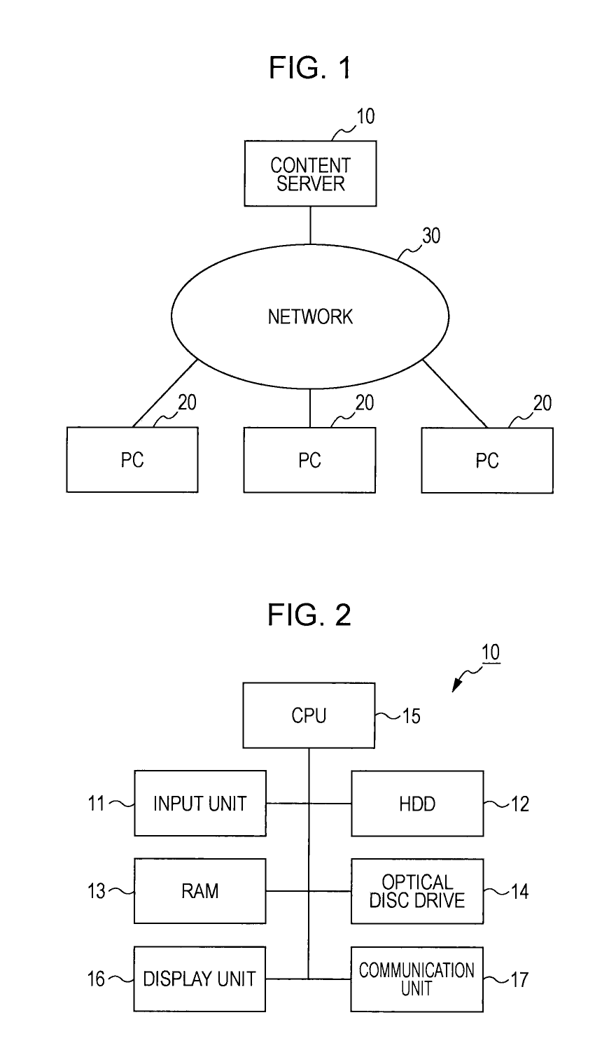

FIG. 1 is a diagram showing a network configuration of an information retrieval system 1 of an embodiment of the invention.

In addition, in the present embodiment, for example, the information retrieval system 1 will be described as a system for retrieving support information of a PC.

In FIG. 1, the information retrieval system 1 includes a content server 10 and a plurality of PCs (terminal devices) 20, and the content server 10 and the PCs 20 can perform communication through a network 30. In addition, the plurality of PCs 20 is configured Built to order (BTO) by assembling parts selected by users and is different in device configuration.

First, the configurations of the content server 10 will be described.

FIG. 2 is a block diagram showing the functional configurations of the content server 10.

In FIG. 2, the content server 10 includes an input unit 11, a Hard Disc Drive (HDD) 12, a Random Access Memory (RAM) 13, an optical disc drive 14, a Central Processing Unit (CPU) 15, a display unit 16 and a communication unit 17.

The input unit 11 includes pointing devices such as a keyboard having cursor keys and/or numerical input keys and a mouse, and outputs a pressing signal of a pressed key of the keyboard or a positional signal of the mouse to the CPU 15.

The HDD 12 stores various programs for controlling the content server 10, such as programs (hereinafter, referred to as a “content retrieval processing program”) for a content retrieval process (described later) for retrieving contents of support information, and a support information database for storing the contents of the support information provided to the PCs 20.

In addition, the support information database may be stored not only in the HDD 12 of the content server 10 and but also in a database server connected through the network 30, such that the content server 10 can appropriately acquire the contents of the support information from the database server. Even in this case, the content server 10 may substantially store a support information database.

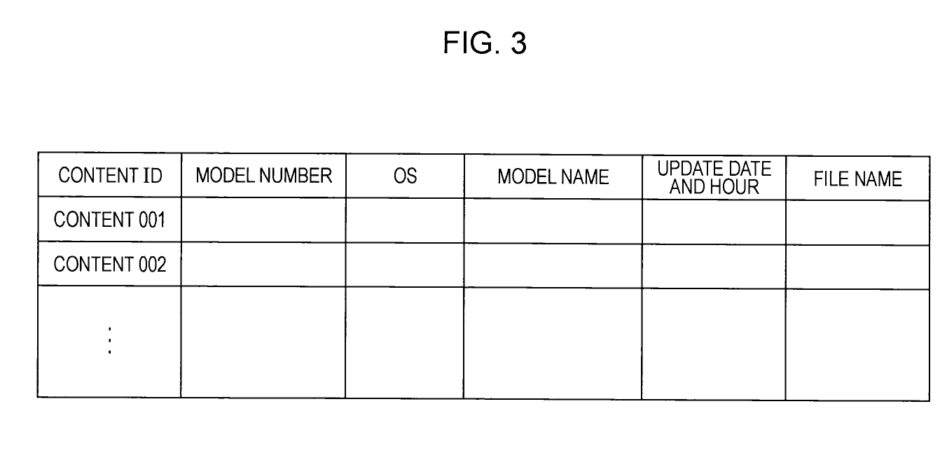

FIG. 3 is a diagram showing the contents of the support information database.

In FIG. 3, in the support information database, the content IDs, the model number of the PC or the name of a part, an Operating System (OS) corresponding to the contents, a corresponding model name, the update date and hour of the contents, and the name of a file for storing substantial data of the contents are stored. The file represented by the file name is stored in the HDD 12 as a portion of the support information database.

Returning to FIG. 2, the RAM 13 forms a work area when the CPU 15 executes various processes and temporarily stores data generated in the processes or data used for the processes.

The optical disc drive 14 is a device for performing reading or writing of an optical disc such as a Digital Versatile Disc (DVD) or a Compact Disc (CD).

The CPU 15 controls the overall content server 10, and reads and executes programs for the various processes stored in the HDD 12 according to various instruction signals input from the input unit 11. At this time, the CPU 15 stores the result of executing various programs in a storage region of the HDD 12 or the RAM 13, or displays the result on the display unit 16.

For example, when the CPU 15 receives a retrieval request of the support information from each of the PCs 20, the CPU 15 reads a content retrieval processing program, executes a content retrieval process, refers to a retrieval condition included in the retrieval request, and acquires contents which coincide with the retrieval condition from the support information database.

In addition, the CPU 15 transmits the retrieved contents to each of the PCs 20 which performs the retrieval request.

In addition, in the present embodiment, the retrieval request transmitted from each of the PCs 20 includes a query, and the CPU 25 performs conceptual retrieval of the query in the support information database. In addition, the CPU 25 transmits a score (information indicating a degree of coincidence of a concept) acquired as the result of the conceptual retrieval to each of the PCs 20 together with the retrieved contents.

The display unit 16 is composed of a liquid crystal display or an organic Electroluminescence (EL) display so as to display a variety of data which is indicated by the CPU 15.

The communication unit 17 includes a communication interface for transmitting or receiving data through the network 30, and performs encoding and decoding of data or modulation or demodulation of a signal based on a predetermined communication protocol, when data is transmitted or received through the network 30.

Next, the configurations of the PC 20 will be described.

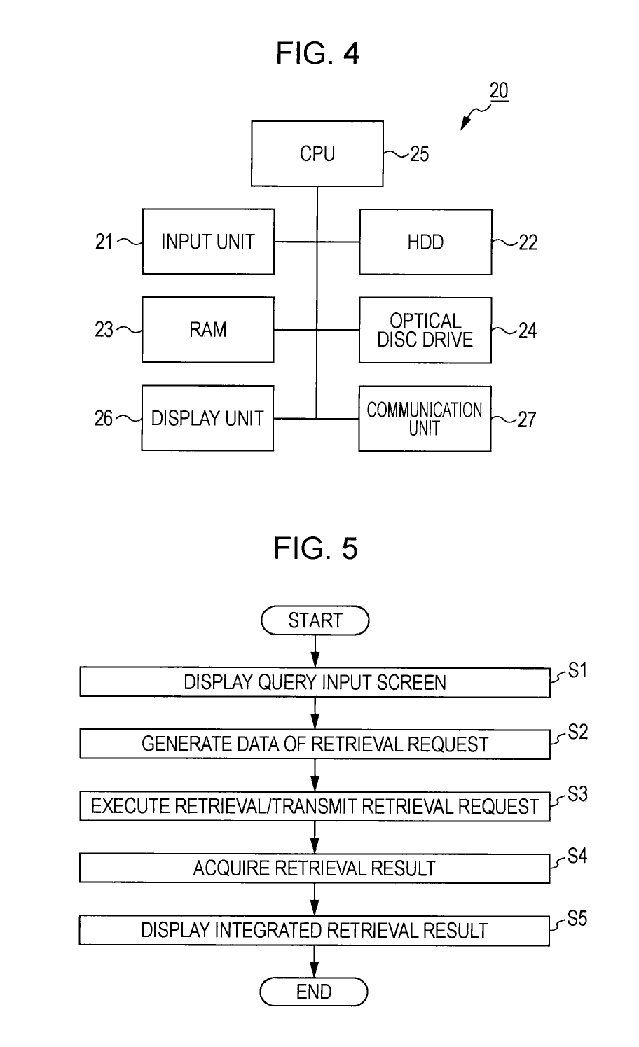

FIG. 4 is a block diagram showing the functional configurations of the PC 20.

In FIG. 4, the PC 20 includes an input unit 21, a HDD 22, a RAM 23, an optical disc drive 24, a CPU 25, a display unit 26 and a communication unit 27.

In the functional configurations shown in FIG. 4, since the portions other than the HDD 22 and the CPU 25 are equal to the corresponding functional configurations of the content server 10 shown in FIG. 2, only the HDD 22 and the CPU 25 will be described.

The HDD 22 stores a program (hereinafter, referred to as an “integrated retrieval processing program”) for an integrated retrieval process (described later) of retrieving support information and providing a retrieval result to a user, various programs for controlling the PC 20, and information (hereinafter, referred to as “configuration information”) for specifying the configuration of the PC 20, such as the model number of the PC 20, the name of a part, and the type of OS.

In addition, the HDD 22 stores some of contents of the support information stored in the support information database of the content server 10. In addition, hereinafter, a data group of the support information stored in the HDD 22 is referred to as a “local database”.

In the local database, support information associated with the configuration of the PC 20 out of the contents stored in the support information database of the content server 10 is stored by a seller or a manufacturer of the PC 20 before shipment.

Some of the support information in the local database is updated when the PC 20 accesses the content server 10.

In addition, in the local database, support information (hereinafter, referred to as “network troubleshooting information”) is stored for solving a problem which prevents the PC 20 from accessing the network 30.

The CPU 25 controls the overall PC 20 and reads and executes a program for various processes stored in the HDD 22 according to various instruction signals input from the input unit 21. At this time, the CPU 25 stores the result of executing the various programs in a storage region of the HDD 22 or the RAM 23, or displays the result on the display unit 26.

For example, the CPU 25 reads and executes the integrated retrieval processing program from the HDD 22, when a retrieval request of support information is input by a user through the input unit 21.

By executing the integrated retrieval processing program, the CPU 25 transmits the retrieval request obtained by adding the configuration information of the PC 20 to the retrieval condition input by the user to the content server 10 and retrieves the local database based on the retrieval request.

At this time, the retrieval request is input by entering a query. The CPU 25 performs the conceptual retrieval of the query when retrieving the local database and acquires the retrieval result in a state of adding a score to the retrieved contents. In addition, the score of the retrieved contents is also added to the retrieval result transmitted from the content server 10. The CPU 25 merges the retrieval result transmitted from the content server 10 and the retrieval result of the local database based on the score included in the retrieval result and displays an integrated retrieval result as a list in response to the retrieval request.

When the retrieval request of the support information is input by the user and the PC 20 cannot access the content server 10 through the network 30, the CPU 25 retrieves the local database and provides the network troubleshooting information to the user. By providing the network troubleshooting information to the user, when the PC 20 can access the content server 10 through the network 30, the CPU 25 executes the retrieval of the support information input by the user again.

### Operation

Next, the operation will be described.

FIG. 5 is a flowchart showing an integrated retrieval process executed by a CPU 25 of the PC 20.

The integrated retrieval process is started up in correspondence with the input of the instruction of the execution of the integrated retrieval process by the user of the PC 20.

In FIG. 5, when the integrated retrieval process is started, the CPU 25 displays a query input screen which instructs the user to enter a query indicating necessary support contents (step S1).

In addition, when the user inputs the query, the CPU 25 adds the configuration information of the PC 20 to the query so as to generate data as a retrieval request (step S2).

Next, the CPU 25 executes conceptual retrieval of the query with respect to the local database and transmits the data of the retrieval request including the query and the configuration information to the content server 10 (step S3).

In addition, in the content server 10, a content retrieval process is executed in corresponding with the reception of the retrieval request of the PC 20.

In step S3, when the content server 10 cannot be accessed through the network 30, the CPU 25 executes a sub flow (hereinafter, referred to as “network trouble resolving process”) for resolving network trouble.

After step S3, the CPU 25 acquires the retrieval result of the local database and the retrieval result received from the content server 10 (step S4).

In addition, the CPU 25 merges the retrieval results acquired in step S4 based on the score and displays one retrieval result on a screen as a list (step S5). At this time, if the retrieval result of the local database and the retrieval result of the support information database have the same score, the CPU 25 preferentially displays the retrieval result of the local database at the top.

By executing the integrated retrieval process, the user can simultaneously search the local database and the support information database, and easily check the retrieval result since the retrieval result is displayed in an integrated form.

Next, the network trouble resolving process which is the sub flow of step S3 of the integrated retrieval process will be described.

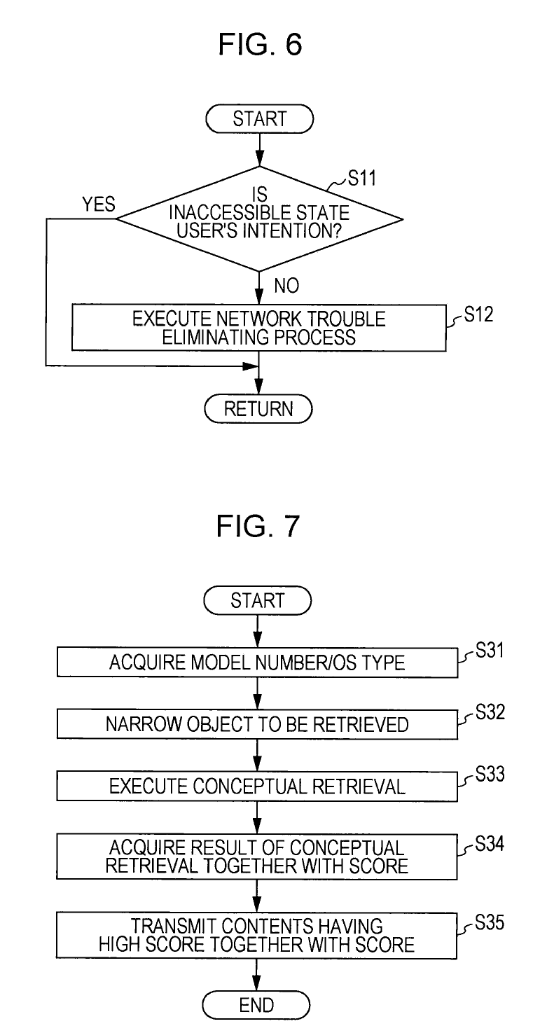

FIG. 6 is a flowchart showing the network trouble resolving process executed by the CPU 25.

In step S3 of FIG. 5, if the network trouble resolving process is invoked, the CPU 25 determines whether the state in which the content server 10 cannot be accessed through the network 30 is the intention of the user (step S11). At this time, the CPU 25 determines the intention of the user depending on, for example, whether or not the user inputs an instruction for performing an offline operation.

If it is determined that the state in which the content server 10 cannot be accessed is the intention of the user, then the CPU 25 returns to step S3 of the integrated retrieval process.

In contrast, in step S11, if it is determined that the state in which the content server 10 cannot be accessed is not the intention of the user, then the CPU 25 acquires network troubleshooting information from the local database and executes the network trouble resolving process (step S12). At this time, the CPU 25 suggests the issues which may cause network trouble to the user and enables the operation of sequentially checking the issues so as to resolve the network trouble.

After step S12, the CPU 25 returns to step S3 of the integrated retrieval process.

In addition, if the state in which the content server 10 cannot be accessed through the network 30 is not resolved by the result of executing the network trouble resolving process, the CPU 25 performs only the retrieval of the local database.

Next, the content retrieval process executed by the CPU 15 of the content server 10 will be described.

FIG. 7 is a flowchart showing the content retrieval process executed by the CPU 15 of the content server 10.

The content retrieval process is started up in correspondence with the transmission of the retrieval request from the PC 20.

In FIG. 7, if the content retrieval process is started, the CPU 15 acquires a model number and an OS type from the configuration information included in the retrieval request (step S31) and narrows an object to be retrieved from the support information database by the acquired model number and the OS type (step S32).

Next, the CPU 15 executes the conceptual retrieval of the query with respect to the narrowed object to be retrieved from the support information database (step S33).

In addition, the CPU 15 acquires the result of the conceptual retrieval together with the score of contents (step S34) and transmits contents having a high score to the PC 20 together with the score (step S35). At this time, the contents to be transmitted to the PC 20, which have scores equal to or greater than a predetermined threshold, are limited in number.

After step S35, the CPU 15 finishes the content retrieval process.

As described above, in the information retrieval system 1 according to the present embodiment, when the user of the PC 20 inputs the query for retrieving the support information, the retrieval of the support information based on the query is performed with respect to the local database, the configuration information of the PC 20 is added to the sentence input by the user, and the retrieval request is transmitted to the content server 10.

In addition, the content server 10 performs the conceptual retrieval based on the query with respect to the narrowed object to be retrieved by the configuration information in the information of the support information database and transmits the result to the PC 20 together with the score.

In addition, the PC 20 merges the retrieval result of the local database and the retrieval result transmitted from the content server 10 according to the score and provides one integrated retrieval result to the user.

Accordingly, the user can efficiently retrieve the support information stored in the PC 20 and the support information accumulated in the content server 10 and browse the retrieval result in a form for easily facilitating the checking of the result.

That is, according to the information retrieval system 1 according to the present embodiment, it is possible to efficiently retrieve the information stored in the terminal device and the information accumulated on the network and to provide the retrieval result in a form for easily facilitating the checking of the result.

In the above embodiment, the PC 20 of FIG. 1 configures an information retrieval device, the HDD 22 of FIG. 4 configures a content storage unit, the input unit 21, the CPU 25 and the display unit 26 of FIG. 4 configure a retrieval request reception unit, the CPU 25 for executing step S4 of FIG. 5 configures a first retrieval unit, the CPU 25 for executing step S4 of FIG. 5 configures a second retrieval unit, and the CPU 25 for executing step S5 of FIG. 5 configures an integrated retrieval result display unit.

In addition, the HDD 22 of FIG. 4 for storing the configuration information or a BIOS for storing a product serial number or the like configures an identification information storing unit.

### Application 1

Although, in the first embodiment, the configuration information is stored in the PC 20, instead of the configuration information, the product serial number (unique product number) of the PC 20 may be stored in a BIOS or the like and the configuration information of the PC 20 may be acquired based on the product serial number.

In detail, a configuration database in which the product serial number of the PC 20 is associated with the configuration information for specifying the part or the like configuring the PC 20 is accumulated in the content server 10 or another server, and the configuration database is retrieved when the retrieval request of the support information is input so as to specify the configuration of the PC 20. Since the configuration information of the PC 20 is identified by a seller or a manufacturer of the PC 20 before shipment even when being purchased BTO or the like, the data of the configuration database may be input by the seller or the manufacturer.

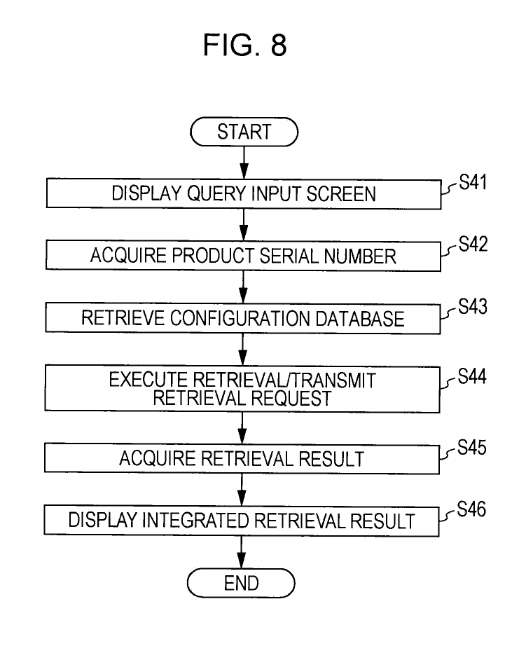

FIG. 8 is a flowchart showing an integrated retrieval process according to Application 1.

In FIG. 8, when the integrated retrieval process is started, the CPU 25 displays a query input screen to prompt the input of a query indicating necessary support contents to the user (step S41).

In addition, when the user inputs the query, the CPU 25 acquires the product serial number of the PC 20 stored in the BIOS or the like (step S42) and retrieves the configuration database of the server based on the product serial number (step S43).

In addition, the CPU 25 executes conceptual retrieval of the query with respect to the local database and transmits the data of the retrieval request including the query and the configuration information to the content server 10 (step S44).

In addition, in the content server 10, a content retrieval process is executed in corresponding with the reception of the retrieval request of the PC 20.

After step S44, the CPU 25 acquires the retrieval result of the local database and the retrieval result received from the content server 10 (step S45).

In addition, the CPU 25 merges the retrieval results acquired in step S45 based on the score and displays one retrieval result on a screen as a list (step S46).

Accordingly, it is possible to efficiently retrieve the support information stored in the PC 20 and the support information accumulated in the content server 10 based on the product serial number stored in the PC 20 and to browse the retrieval result in a form for easily facilitating the checking of the result.

### Application 2

Although, in Application 1, the product serial number is stored in the PC 20 and the configuration information is acquired based thereon, a product number (hereinafter, referred to as a “dedicated product number of a product for a company”) of the PC 20 configured for a specific company may be stored in addition to the unique product serial number of the PC 20, and the configuration information may be acquired based thereon.

In this case, in the configuration database of Application 1, the dedicated product number of the product for the company is stored in correspondence with the configuration information for specifying the parts or the like configuring the PC 20.

Accordingly, it is possible to efficiently retrieve the support information stored in the PC 20 and the support information accumulated in the content server 10 based on the dedicated product number of the product for the company stored in the PC 20 and to browse the retrieval result in a form for easily facilitating the checking of the result.

### Application 3

Although, in the first embodiment, when the content retrieval process is executed, the example in which the content server 10 determines the retrieval result transmitted to the PC 20 based on the score acquired by the conceptual retrieval is described, the score acquired by the conceptual retrieval may be corrected so as to determine a final retrieval result.

For example, in the content server 10, a statistical process may be performed with respect to the retrieval of the support information performed by the plurality of PCs 20, the result of the conceptual retrieval of the query may be corrected with respect to the contents having the retrieval result of the support information performed by the PCs 20 having the same or similar configuration, and the score may be added by a set value, thereby determining the retrieval result.

After the shipment of the PC 20 which is subjected to the retrieval of the support information, when the support information associated with the PC 20 is opened or updated, the score may be added to the opened or updated support information by the set value so as to determine the retrieval result.

Therefore, by correcting the score acquired as the result of the conceptual retrieval, it is possible to provide the support information having higher relevance to the configuration of the PC 20.

The entire disclosure of Japanese Patent Application No. 2009-010642, filed Jan. 21, 2009 is expressly incorporated by reference herein.

What is claimed is:

1. An information retrieval device connected to a content server which stores contents to be retrieved through a network, the information retrieval device comprising:
a content storing unit storing contents including some of the contents stored in the content server;
a retrieval request reception unit receiving contents retrieval request for the content server and the content storing unit;
a first retrieval unit acquiring a first retrieval result of the contents stored in the content storing unit based on the retrieval request received by the retrieval request reception unit;
a second retrieval unit acquiring a second retrieval result of the contents stored in the content server based on the retrieval request received by the retrieval request reception unit; and
an integrated retrieval result display unit displaying an integrated retrieval result obtained by integrating the first retrieval result and the second retrieval result.

2. The information retrieval device according to claim 1, further comprising an identification information storing unit storing an identification information specifying the configuration of the information retrieval device,
wherein the second retrieval unit acquires the second retrieval result of the contents stored in the content server based on the retrieval request received by the retrieval request reception unit and the identification information stored in the identification information storing unit.

3. The information retrieval device according to claim 1, wherein the integrated retrieval result display unit displays the integrated retrieval result in order of the score of the contents of the retrieval request, and displays contents included in the first retrieval result at the top when the contents included in the first retrieval result and the contents included in the second retrieval result have the same score.

4. The information retrieval device according to claim 1, wherein:
the contents to be retrieved is support information used for supporting the use of the information retrieval device, and
the content storing unit stores contents used for troubleshooting connection problems of the network.

5. An information retrieval system in which a content server, which stores contents to be retrieved, and an information retrieval device, which performs a retrieval request of the contents to be retrieved, are connected through a network, wherein:
the content server includes:
a content database storing contents to be retrieved; and
a content retrieval unit performing retrieval of the contents stored in the content database according to the retrieval request of the information retrieval device, and
the information retrieval device includes:
a content storing unit storing contents including some of the contents stored in the content server;
a retrieval request reception unit receiving contents retrieval requests for the content server and the content storing unit;
a first retrieval unit acquiring a first retrieval result of the contents stored in the content storing unit based on the retrieval request received by the retrieval request reception unit;
a second retrieval unit acquiring a second retrieval result of the contents stored in the content server based on the retrieval request received by the retrieval request reception unit; and
an integrated retrieval result display unit displaying an integrated retrieval result obtained by integrating the first retrieval result and the second retrieval result.

6. An information retrieval program for controlling an information retrieval device which is connected to a content server storing contents to be stored and has a content storing unit storing contents including some of the contents stored in the content server, which executes, on a computer, the information retrieval program comprising:
a retrieval request reception function of receiving contents retrieval requests for the content server and the content storing unit;
a first retrieval function of acquiring a first retrieval result of the contents stored in the content storing unit based on the retrieval request received by the retrieval request reception function;
a second retrieval function of acquiring a second retrieval result of the contents stored in the content server based on the retrieval request received by the retrieval request reception function; and
an integrated retrieval result display function of displaying an integrated retrieval result obtained by integrating the first retrieval result and the second retrieval result.

7. An information retrieval method of an information retrieval system in which a content server storing contents to be retrieved and an information retrieval device, which has a content storing unit storing contents including some of the contents stored in the content server and performs a retrieval request of the contents to be retrieved, are connected through a network, the information retrieval method comprising:
receiving a retrieval request of the contents stored in the content server and the content storing unit, in the information retrieval device;
performing retrieval of the contents stored in a content database according to the retrieval request of the information retrieval device, in the content server having the content database storing contents to be retrieved;
acquiring a first retrieval result of the contents stored in the content storing unit based on the received retrieval request, in the information retrieval device;
acquiring a second retrieval result of the contents stored in the content server based on the received retrieval request, in the information retrieval device; and
displaying an integrated retrieval result obtained by integrating the first retrieval result and the second retrieval result, in the information retrieval device.
